(19) United States
(12) Patent Application Publication
(10) Pub. No.: US 2022/0331846 A1
(43) Pub. Date: Oct. 20, 2022

(54) CLEAN-IN-PLACE AND PRODUCT RECOVERY METHOD

(71) Applicant: BWXT Isotope Technology Group, Inc., Lynchburg, VA (US)

(72) Inventors: Jon H. ANDERSSON, Charlotte, NC (US); Curtis G. HAMILTON, Lynchburg, VA (US)

(21) Appl. No.: 17/718,659

(22) Filed: Apr. 12, 2022

Related U.S. Application Data
(60) Provisional application No. 63/175,885, filed on Apr. 16, 2021.

(51) Int. Cl. B08B 7/00; B08B 5/02; B08B 9/027; B08B 9/093

(52) U.S. Cl. CPC B08B 7/0071; B08B 5/02; B08B 9/027; B08B 9/093; B08B 2209/027; B08B 2209/08

(57) ABSTRACT

A method of cleaning is provided in which heat is applied to a pipe, vessel, process equipment, filter or associated fitting(s) in a system having chemical or nuclear material, and the application of heat results in cleaning in place without disassembly of the system and/or recovery of product.

### CROSS-REFERENCE TO RELATED APPLICATION

This utility application claims priority from U.S. provisional patent application No. 63/175,885, filed on Apr. 16, 2021, in the United States Patent and Trademark Office. The disclosure of which is incorporated herein by reference in its entirety.

### FIELD OF THE INVENTION

The present invention relates to a method of clean-in-place (CIP) cleaning, more particularly to a method of using heat for clean-in-place (CIP) cleaning and product recovery.

### BACKGROUND OF THE INVENTION

In industry, clean-in-place (CIP) is a method of cleaning the interior surfaces of pipes, vessels, process equipment, filters and associated fittings, without disassembly. There are existing methods for clean-in-place that use water, chemicals, dry ice, or physical means of cleaning equipment, vessels, and piping.

In a liquid CIP system, water is often the liquid added to a chemistry vessel via spray nozzle(s) to rinse off the sides. The water and residual material are agitated in the chemistry vessel, and the water is pumped from the chemistry vessel through piping and into other equipment and systems or to waste.

There are numerous disadvantages associated with liquid CIP systems including high energy costs, waste disposal issues, and greater equipment costs, among others. Extra liquid is added to the system. The liquid either gets carried through the equipment or gets discarded as waste water. Such method, for example, increases the amount of drying time or increases the amount of waste water generated.

The method of the present invention is directed to a new CIP method that overcomes these disadvantages.

### SUMMARY OF THE INVENTION

The present invention relates to a method to be used primarily as a clean-in-place (CIP) cleaning method and for product recovery purposes.

In an embodiment of the invention, a method of cleaning is provided. The method comprises applying heat to a pipe, vessel, process equipment, filter and associated fitting(s) in a system comprising chemical or nuclear material, wherein the application of heat results in cleaning in place without disassembly of the system.

In an embodiment of the invention, a method of product recovery is provided. The method comprises applying heat to a pipe, vessel, process equipment, filter or associated fitting(s) in a system comprising chemical or nuclear material, wherein the application of heat results in recovery of product.

In an aspect of the invention, application of heat occurs by blowing hot air.

In an aspect of the invention, application of heat occurs by direct heat externally.

In an aspect of the invention, application of heat occurs by an external heat gun.

In an aspect of the invention, the application of heat occurs at a temperature above a destruction temperature of a product.

In an aspect of the invention, the method further comprises blowing out with air the pipe, vessel, process equipment, filter, or associated fitting.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

The present invention is a method to be used primarily as a clean-in-place (CIP) cleaning method and/or for product recovery.

The method comprises applying heat to a pipe, vessel, process equipment, filter and associated fitting(s), without disassembly. Heat can be applied by a variety of techniques in accordance with the present invention. Heat can be applied by direct heat externally such as through a jacket to a pipe, vessel, process equipment, filter and associated fitting(s). Heat can be applied by an external heat gun. Heat can be applied by blowing heated air and/or other gases through the piping and/or other system equipment.

Preferably, heat is applied at a temperature above a destruction temperature of a product to cause it to flake off. By heating, the characteristics of the product changes. Heat is applied to heat up product residue and cause it to flake or peel off, and then blow out with air to reduce need for cleaning agents.

In order to clean material transfer lines such as in a chemical or nuclear facility, heat can be used in replacement of or in conjunction with a liquid clean-in-place process. For example, the method of the present invention could be used to clean a chemistry vessel system (CVS) and/or a product wash system (PWS). The method could also be used to clean wetted surfaces in contact with temperature dependent chemical or pharmaceutical products.

The cleaning method of the present invention can be used in a variety of applications. One such application is pipe cleaning and/or product wash system (PWS) cleaning. For example, once washed and concentrated slurry is transferred to a nutsche (filter), and heated air is blown through the PWS. Material will progressively flake off and be blown downstream. The dried material from the piping can be transferred to the nutsche (filter) and can be combined with the rest of the batch. If not implemented into the process, the method can at least be applied to cleaning the crossflow filters in the PWS. The material inside will dry and can simply be tapped out. This has proven more effective at removing clogged material than a simple water rinse.

Another such application is tank cleaning. Similar to the above, once the material is out of a chemistry vessel and transferred to the nutsche (filter), the chemistry vessel can be heated. The material will flake off the sides and collect in the bottom of the tank. That material can also be vacuum transferred to the nutsche (filter) or remain in the vessel until it is cleaned.

In some processes a slurry having a viscosity like pudding is pumped through pipes and/or filters and leaves a residue in the chemical vessels and piping. The method of the present invention can be used to reduce the amount of product left behind.

Among the advantages of the method of the present invention are potential high product recovery which can increase product yield and revenue, reduced waste water generation, and easier cleaning for piping and PWS components because of less residual material in piping and systems, cleaner end product, and a less intense cleaning procedure.

### Example 1

A pipe cleaning test was conducted in accordance with the present invention. A heat gun was used to remove residual concentrated material in a 1″ Inner Diameter (ID) plastic pipe. Concentrated slurry was poured down the pipe. The pipe was oriented vertically to allow material to flow out of the bottom. The heat gun was then used to blow hot air down the tube to dry the residual material. The slurry visibly dried and flaked off close to the heat gun. The pipe progressed from empty, to the wetted material, and then to partially cleaned. The test lasted roughly five (5) minutes. Photographs were taken showing the pipe empty. Photographs were taken showing the pipe wetted with material. Photographs were taken showing the pipe partially cleaned.

### Example 2

A tank cleaning test was conducted on a recirculation tank. An external electric heater was used to remove concentrated slurry from a stainless steel tank surface. Concentrated slurry was spread around the inner surface of the stainless steel tank. An external heater was turned on. The experiment lasted around five minutes. A photograph was taken before the heater was turned on. Photographs were taken after the heater was on for about five minutes. There was a visible difference between the heated surface and the non-heated surface. Where the heat was in contact with the tank, the material was clearly seen flaking off of the sides.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method comprising:
applying heat to a pipe, vessel, process equipment, filter, or associated fitting in a system comprising chemical or nuclear material, wherein the application of heat results in cleaning in place without disassembly of the system.

2. The method according to claim 1, wherein application of heat occurs by blowing hot air into the pipe, vessel, process equipment, filter, or associated fitting.

3. The method according to claim 1, wherein application of heat occurs by direct heat externally.

4. The method according to claim 1, wherein application of heat occurs by an external heat gun.

5. The method according to claim 1, wherein application of heat occurs at a temperature above a destruction temperature of a product.

6. The method according to claim 1, further comprising blowing out with air the pipe, vessel, process equipment, filter, or associated fitting.

7. A method comprising:
applying heat to a pipe, vessel, process equipment, filter, or associated fitting in a system comprising chemical or nuclear material, wherein the application of heat results in recovery of product.

8. The method according to claim 7, wherein application of heat occurs by blowing hot air into the pipe, vessel, process equipment, filter, or associated fitting.

9. The method according to claim 7, wherein application of heat occurs by direct heat externally.

10. The method according to claim 7, wherein application of heat occurs by an external heat gun.
